(19) United States
(12) Patent Application Publication
(10) Pub. No.: US 2008/0059106 A1
(43) Pub. Date: Mar. 6, 2008

(54) Diagnostic applications for electronic equipment providing embedded and remote operation and reporting

(76) Inventors: Alan N. Wight, Petaluma, CA (US); James M. Dematteis, Santa Rosa, CA (US); Philippe Andre Melman, Occidental, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/515,059

(22) Filed: Sep. 1, 2006

(51) Int. Cl. G06F 19/00

(52) U.S. Cl. 702/119

(57) ABSTRACT

A system for running a diagnostic on a piece of equipment comprises a testing apparatus, embodied within the piece of equipment, the apparatus executing diagnostic tests responsive to test execution commands, and producing diagnostic test results. A command receiver, embodied within the piece of equipment, receives the test execution commands. A data store interface for formatting the diagnostic test results and providing the formatted diagnostic test results to a diagnostic test results data store.

### BACKGROUND OF THE INVENTION

The present invention relates to diagnostic testing for electronic equipment.

Conventional diagnostic testing arrangements have involved coupling a test system, such as a production line Unix workstation, to an instrument or piece of equipment to be tested. Troubleshooting software applications, in the form of BASIC or C language programs or shell scripts, etc., reside within the test system.

When such troubleshooting software applications are executed, the test system, and the instrument to be tested, communicate through a communication interface. For instance, many such troubleshooting applications use an IEEE 488 General Purpose Interface Bus (GPIB) connection between the UNIX workstation and the instrument.

It would be advantageous to employ standard network communications for such diagnostic testing, obviating the need for a diagnostic-specific interface such as the GPIB and allowing for remote testing. It would also be advantageous to execute diagnostic testing on-board the equipment to be tested.

### SUMMARY OF THE INVENTION

A system for running a diagnostic on a piece of equipment comprises a testing apparatus, embodied within the piece of equipment, the apparatus executing diagnostic tests responsive to test execution commands, and producing diagnostic test results. A command receiver, embodied within the piece of equipment, receives the test execution commands. A data store interface for formatting the diagnostic test results and providing the formatted diagnostic test results to a diagnostic test results data store.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a block diagram showing the operational environment of a piece of equipment, to undergo diagnostic testing as per an embodiment of the invention.

FIG. 2 is a flowchart showing diagnostic test operation of a piece of equipment embodying the invention.

FIG. 3 is a flowchart showing operation of a remote test controller for testing a piece of equipment embodying the invention.

FIGS. 4 and 5 are examples of graphical user interfaces for permitting an operator to test a piece of equipment as per an embodiment of the invention.

### DETAILED DESCRIPTION

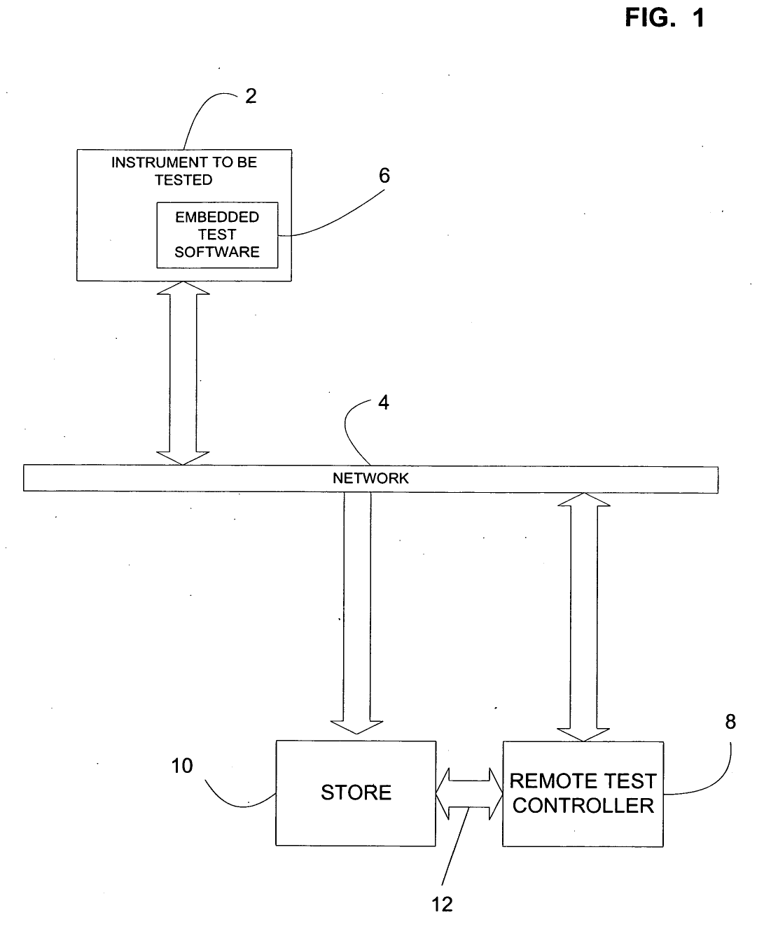

FIG. 1 is a system block diagram, showing an operating environment in which a piece of equipment operates, and within which an embodiment of the invention is illustrated. For the purpose of the discussion which follows, the terms “piece of equipment”, “electronic equipment”, “instrument”, and the like are used interchangeably, and are to be understood broadly, without limitation.

An instrument 2, as just described, is shown as being coupled for communication to a communication network 4, which can be the Internet, a local area network, etc. In an embodiment of the invention, an on-board test apparatus, shown as embedded test software 6, is provided within the instrument 2. The test software 6 will be described in more detail below.

The network 4, being a general purpose communication network as described above, may also have a variety of devices, pieces of equipment, communication nodes, etc, coupled for communication over it. In an embodiment of the invention, a test controller 8 is shown as coupled for such communication over the network 4. The test controller may be in proximity to the instrument 2, or may be at a remote location, for the system architect's or the test operator's convenience. To illustrate this point without limitation, the test controller 8 is labeled as being a “remote” test controller 8. The test controller 8 communicates with the instrument 2, to operate the on-board test apparatus (for instance, to cause the embedded test software 6 to execute), by means of communications over the network 2.

By contrast, conventional test solutions have employed troubleshooting applications resident on test systems such as production line UNIX workstations, employing software written in Basic, C, shell scripts, etc. These conventional applications have required a IEEE 488 General Purpose Interface Bus (GPIB) connection between the UNIX workstation and the instrument. It will be seen, then, that the conventional test systems have had to be transported to the location of the instrument to be tested, and the GPIB bus has had to be installed separately from the network 2.

Such a required GPIB connection, or the like, has limited the ways in which system operators have been able to perform tests. For instance, it has not been possible to install test software on the equipment for testing controlled remotely, at the behest of commands sent by a remote system operator over a standard communication network such as a Local Area Network (LAN).

In the illustrated (FIG. 1) embodiment of the invention, however, it is possible to test, or troubleshoot, the instrument 2 from a remote service center, where the remote test controller 8 is located.

Also, since the test software 6 is on-board the instrument 2, it is also possible for a customer/operator of the instrument 2 to operate the test software 6 in an embedded or stand-alone mode. This is done by using a local user interface (not shown), which may include a display, keyboard and mouse interface, etc. In one embodiment, the interface is Windows-based. The operator of the instrument 2 uses the interface devices to give local test commands to cause the embedded test software 6 to execute without the need of an external controller 8.

The remote test controller 8 may be located in a service center. For instance, the service center might operate subscriber services, in which a service center operator performs routine testing, troubleshooting of reported problems, performance surveys, etc., for instance by performing a remote desktop connection log-in sequence on an instrument 2 having a Windows-based or other standard user interface, and dispatching test commands over the network 4 to the instrument 2. The instrument 2 executes the tests responsive to the test commands.

For statistical surveys, it is possible to accumulate test reports, which are sent back to the test controller 8 from remote equipment such as the instrument 2,as replies to the test commands. For instance, a memory storage device such as a store 10 may be provided, for instance at the same location as the test controller 8. The store 8 receives test reports transmitted over the network 4 from equipment such as the instrument 2.

The store 10 may be coupled to the test controller 8, either over the network 4 or by a dedicated link 12, to enable the test controller 8 to access and process the test results. In one embodiment, the store 10 may be coupled directly to the network 4, to monitor network traffic, and receive and store all test reply messages addressed to the test controller 8. As test reports accumulate in the store 10, statistics can be calculated, and human-viewable presentations, such as graphics, can be prepared for display.

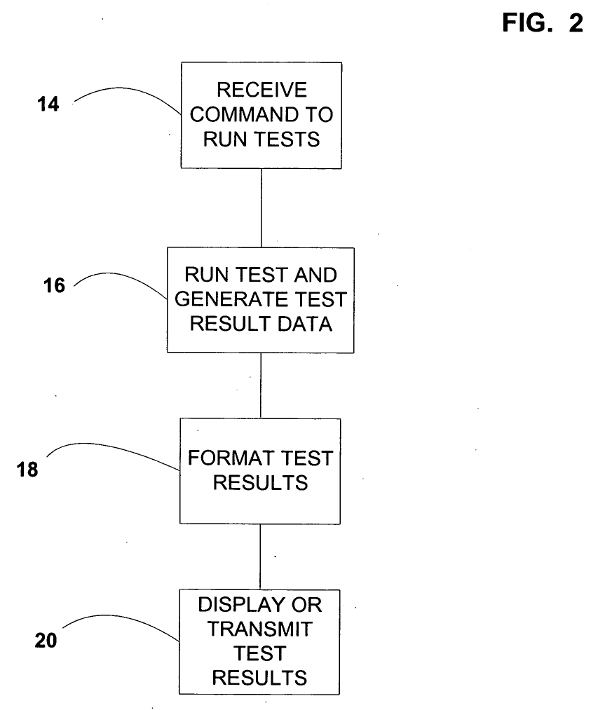

A more detailed description of the operation of the embodiment of FIG. 1 in a remote testing mode will now be given. Reference is also made to FIG. 2, which is a flowchart showing operation of the test software 6, responsive to a received test command.

A test command is received (14), either as a remote command transmitted from the test controller 8 over the network 4, or as a command entered locally by an instrument operator through a user interface of the instrument 2. As noted above, the instrument 2 may employ a Windows-based user interface, or the like. In such cases, the above-mentioned command may also include a Windows log-in sequence, etc.

The test software 6 receives and identifies the command, and performs testing operations (16) appropriate for the type of equipment the instrument 2 is, the type of operation of the instrument 2 that is to be tested, and the type of test report that is desired. Test result data is generated.

The test software 6 then formats the test results (18) into a format suitable for responding to the test command. This can include either formatting (such as packetizing) for transmission over the network 4 to the test controller 8, or formatting in a way suitable for a user interface of the instrument 2, depending on whether the testing is by remote command or in the embedded mode responsive to instrument operator command. Then, the results are either transmitted or displayed locally, as appropriate (20).

In one embodiment, the embedded/remote diagnostic applications are written in the C# language, using the .NET Framework. Communication between the test controller and instruments to be tested is done with SCPI commands using code from the Agilent Test and Measurement Toolkit. Graphical representations of the resultant test data are created using code from the Agilent Test and Measurement Toolkit.

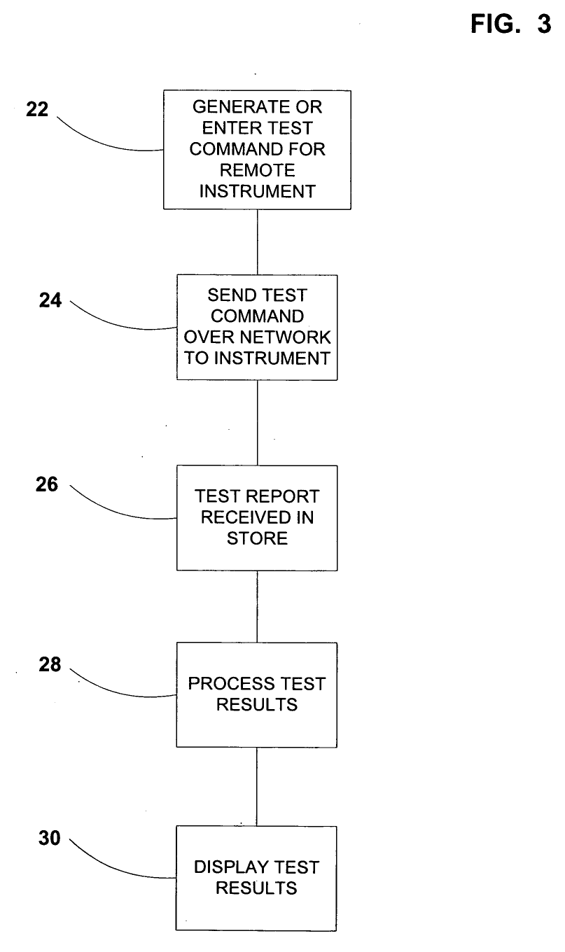

In the case where (14) includes receiving a test command transmitted from the remote test controller 8, the operation of the test controller 8 may be as shown in the flowchart of FIG. 3.

At a remote test center, a human operator or automatic test scheduler generates a test command (22) which, as noted above, may include a log-in sequence, etc. The test command is addressed to a particular piece of equipment at a particular location. The test command instructs that a particular test, or sequence of tests, shall be performed. Such test or sequence of tests is appropriately chosen, based on factors such as the type of equipment or instrument to be test, the nature of its operation, the type of test desired to be run, the type of performance information desired to be obtained, etc. Where a performance history is being maintained, or a survey of test information is sought over a population of instruments (for instance, the same type of instrument, or instruments performing the same type of function, etc.), the test command might be part of a schedule or list set up to support such history or survey.

The test command is transmitted over the network (24), and the test controller 8 waits for a test report in response.

When the instrument 2 transmits (20) the test results report, the report is received (26). The report may be received by the test controller 8 and processed directly. Alternatively, the test controller 8 may store the report in the store 10, by way of the dedicated link 12 or the network 4. In another alternative, the store 10 may directly receive the report from the network 4. If the store 10 has sufficient intelligence, processing capability, etc, it can store and catalog the report for subsequent access by the test controller 8.

The test controller 8 then processes (28) the test results. Such processing can include arrangement into a suitable format for display (30), comparison with previously stored results, compilation of statistics, etc.

The test results, statistics, etc, are displayed (30). Such processing (28) can also include formatting the report for display to the test controller operator.

In alternative embodiments, a graphical test display either (i) updates as the test runs, or (ii) appears at the end of the test. Updating as the test runs may be employed for long-running tests. This “graphically update as you test” can also plot several data variables at once.

In some test applications, graphs may be used, to allow the user to optionally retain existing data plots, when rerunning the test application to generate new data plots. This allows the user to observe the repeatability of the device under test, over multiple test runs. Alternatively, the user interface may be refreshed with new data plots, as the test continues to run, or is re-run.

Where graphs (i.e., with x and y axes) are displayed, either or both of the axes may be autoscalable, such as by user command. Such autoscalability may be useful, for instance when the range of the data cannot easily be anticipated.

Test results may be presented in a hierarchy of displays, menus, etc. From a parent display, the user can use click display buttons, pull-down menus, etc, to view additional report information, such as a list or graph of test results, which otherwise would not be part of the displayed information. In one embodiment, the parent test result display could include an overall PASS or FAIL test sequence result. The user then selects a child test result display, perhaps from a set of alternative child displays. Such parent/child test displays can, for instance, be used where the main user interface form is crowded and extra screen real estate for test results is unavailable.

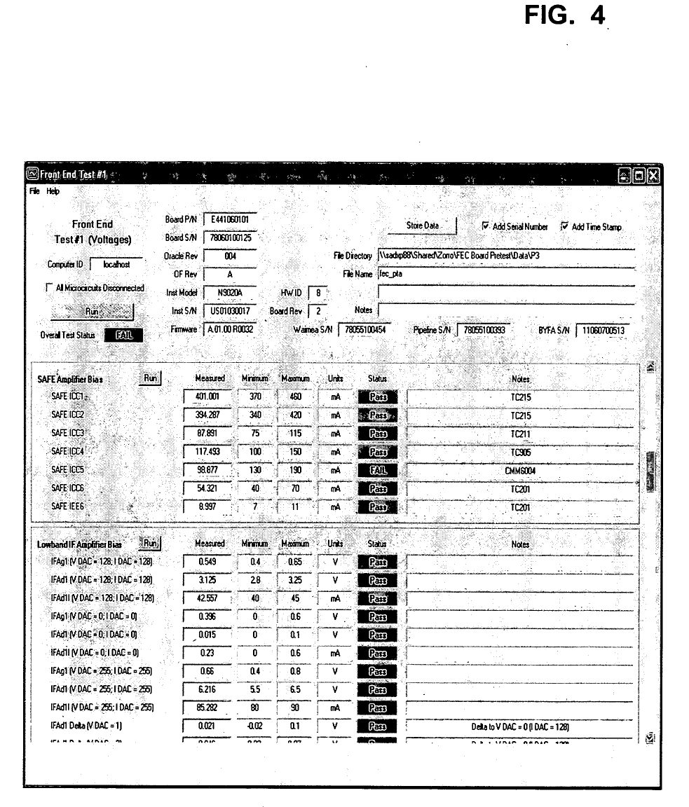

FIG. 4 is an example of a graphical display screen capture for a diagnostic test application running in embedded mode. The application runs on a Windows-based test instrument, and its purpose, broadly speaking, is to measure the performance of the instrument. This application sequences through a series of approximately 155 individual measurements, and then returns an overall test status. The results of the measurements are shown in a list, from top to bottom. In this particular graphical implementation, scrolling is required to see all of the measurements.

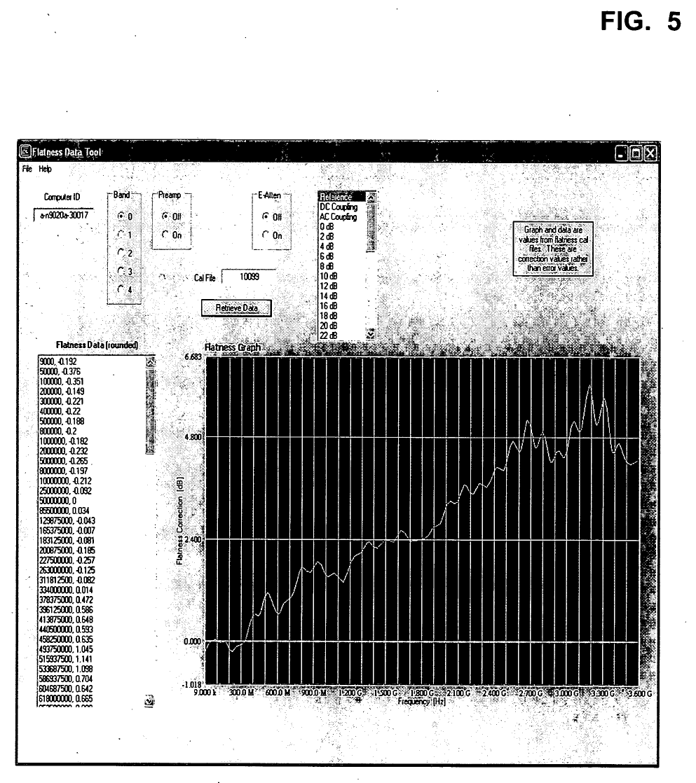

FIG. 5 is an example of a graphical display for a diagnostic test application running remotely. The application runs on a desktop personal computer (PC), which serves as the test controller, and which is connected to a local area network (LAN). The test controller communicates over the LAN with a Windows-based instrument, which is also connected to the LAN, and is to undergo testing. In particular, the purpose of the testing is to gather flatness data from the instrument. In the illustrated example, the instrument reports sets of amplitude vs. frequency (flatness) correction data for a Radiofrequency (RF) instrument. Then, the test controller provides tabular and graphical output of the data, as shown in FIG. 5.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A system for running a diagnostic on a piece of equipment, the system comprising:
a testing apparatus, embodied within the piece of equipment, the apparatus executing diagnostic tests responsive to test execution commands, and producing diagnostic test results;
a command receiver, embodied within the piece of equipment, for receiving the test execution commands;
a data store interface for formatting the diagnostic test results and providing the formatted diagnostic test results to a diagnostic test results data store.

2. A system as recited in claim 1, wherein:
the piece of equipment includes a user interface for allowing an equipment operator to enter test execution commands to the command receiver; and
the testing apparatus is operable responsive to a test execution command entered by the equipment operator.

3. A system as recited in claim 1, wherein:
the piece of equipment is coupled to a communication network, and the testing apparatus is operable responsive to a remote log-in sequence and test execution command received by the piece of equipment over the communication network.

4. A system as recited in claim 1, wherein the testing apparatus, the command receiver, and the data store interface are implemented in software for installation and execution on the piece of equipment.

5. A system as recited in claim 1, wherein:
the testing apparatus includes a menu of diagnostic tests to be performed for the piece of equipment; and
the command receiver recognizes a set of respective diagnostic test commands for the diagnostic tests of the menu.

6. A system as recited in claim 5, wherein the testing apparatus further includes apparatus for executing multiple preselected ones of the diagnostic tests in a preselected sequence, responsive to a test execution command which specifies the multiple preselected diagnostic tests in the preselected sequence.

7. A system as recited in claim 1, further comprising a user interface for providing a visual representation of the diagnostic test results to the operator.

8. A system as recited in claim 7, wherein the user interface includes a graphical user interface for providing the equipment operator with a graphical representation of the diagnostic test results.

9. A system as recited in claim 8, wherein the graphical user interface provides a graphical representation of one of (i) instrument parameters/performance. (ii) instrument amplitude vs. frequency corrections, and (iii) attenuator switching response vs. time.

10. A system as recited in claim 7, further comprising a pass/fail reporting apparatus for providing a concise pass-or-fail diagnostic test result.

11. A system as recited in claim 1, further comprising a test controller, which includes:
a communication interface coupled to the communication network for communication with the piece of equipment; and
an apparatus for communicating a diagnostic test command to the piece of equipment.

12. A system as recited in claim 11, wherein the apparatus for communicating includes a user interface for allowing a test controller operator to enter diagnostic test commands and to cause transmission of the entered diagnostic test commands through the communication interface and the communication network to the piece of equipment.

13. A system as recited in claim 12, wherein:
the user interface further allows the test system operator to receive diagnostic test results sent from the piece of equipment over the communication network; and
the user interface of the test controller provides the diagnostic test results to the test controller operator.

14. A system as recited in claim 13, wherein the user interface of the test controller includes a graphical user interface for providing the test controller operator with a graphical representation of the diagnostic test results.

15. A system as recited in claim 14, wherein the graphical user interface provides a graphical representation of one of (i) instrument parameters/performance, (ii) instrument amplitude vs. frequency corrections, and (iii) attenuator switching response vs. time.

16. A system as recited in claim 14, wherein the user interface of the test controller includes a pass/fail reporting apparatus for providing a concise pass-or-fail diagnostic test result.

17. A system as recited in claim 11, wherein the test controller includes a menu of diagnostic tests to be performed for the piece of equipment, a library of respective diagnostic test commands for the diagnostic tests of the menu, and a user interface for allowing the test system operator to enter respective ones of the diagnostic test commands and to cause transmission of the entered diagnostic test commands to the piece of equipment.

18. A system as recited in claim 11, further comprising a data store for storing and accumulating diagnostic test results.

19. A system as recited in claim 11, wherein the test controller further comprises apparatus for performing a historical analysis of the stored and accumulated diagnostic test results.
